(19) United States
(12) Patent Application Publication
(10) Pub. No.: US 2023/0242739 A1
(43) Pub. Date: Aug. 3, 2023

(54) RUBBER COMPOSITION AND PNEUMATIC TIRE USING SAME

(71) Applicant: Toyo Tire Corporation, Itami-shi (JP)

(72) Inventors: Yuki Tobita, Itami-shi (JP); Tatsuya Endo, Itami-shi (JP)

(73) Assignee: Toyo Tire Corporation, Itami-sh (JP)

(21) Appl. No.: 17/983,473

(22) Filed: Nov. 9, 2022

(30) Foreign Application Priority Data
Dec. 27, 2021 (JP) 2021-213107

(51) Int. Cl. C08K 5/548; C08K 5/5415

(52) U.S. Cl. CPC C08K 5/548; C08K 5/5415

(57) ABSTRACT

A rubber composition contains silica in a diene rubber. A relaxation curve (free induction decay curve) obtained based on the unvulcanized sample is separated into two components, i.e., a component (S₀) having a short relaxation time and a component (L₀) having a long relaxation time. A relaxation curve (free induction decay curve) obtained based on the vulcanized sample is separated into two components, i.e., a component (S) having a short relaxation time and a component (L) having a long relaxation time. A weighted average value (T₀) of a relaxation time of the component (S₀) and a relaxation time of the component (L₀) and a relaxation time (Ts) of the component (S) satisfy T_{S}/T₀ ≥ 0.26. A volume (Vs) of the component (S) and a volume (V_{L}) of the component (L) satisfy V_{S}/V_{L} ≥ 0.26.

### BACKGROUND OF THE INVENTION

### 1. Field of the Invention

The present invention relates to a rubber composition and a pneumatic tire using the rubber composition.

### 2. Description of the Related Art

In recent years, a consideration for the environment has become a social demand, and a demand for low fuel consumption is increasing. Under such circumstances, development of a material having low rolling resistance is required as a material of a tire for a vehicle, in particular, as a material of a tire tread to be in contact with the ground. In addition, from the viewpoint of improving safety of the vehicle, improvement in braking performance (wet grip performance) on a wet road surface is required.

In order to solve such problems, for example, JP-A-2020-100677 discloses that when three types of rubber components and two types of silica are contained and a dispersion ratio of the silica in each rubber component is within a predetermined range, wet performance, wear resistance, and low rolling resistance can be achieved at a high level.

In addition, JP-A-2015-214621 discloses that when Rs indicating a ratio of a constrained phase of a rubber reinforced by silica and a silane coupling agent, which is measured by pulse technique NMR, is in a predetermined range, excellent low hysteresis loss property, wet skid resistance, and wear resistance can be exhibited while ensuring sufficient workability.

As described above, various proposals have been made to improve the wet grip performance and the rolling resistance performance. However, the wet grip performance and the rolling resistance performance are contradictory performance, that is, when one is improved, the other is lowered, and it is required to improve one while preventing deterioration of the other (improvement of conflicting performance).

In a rubber composition described in JP-A-2020-100677, a low Tg rubber component is disposed around the silica. In order to obtain such a configuration, it is necessary to modify the rubber component or to set a procedure for mixing components to be blended. Further, the rubber component near a silica interface is constrained by the silica, and there is a concern that stress caused by external stimulus cannot be sensitively absorbed. Therefore, there is room for improvement in conflicting performance regarding the rolling resistance and the wet grip performance.

In JP-A-2015-214621, a relaxation time of a polymer is not mentioned, and when a constraint for the polymer is too strong, there is a concern that stress caused by external stimulus cannot be sensitively absorbed. Therefore, there is room for improvement in conflicting performance regarding the rolling resistance and the wet grip performance.

### SUMMARY OF THE INVENTION

In view of the above points, an object of the invention is to provide a rubber composition for improving conflicting performance regarding rolling resistance and wet grip performance, and a pneumatic tire using the rubber composition.

A rubber composition according to the invention contains silica in a diene rubber, in which a spin-spin relaxation time of an unvulcanized sample made of the diene rubber and a spin-spin relaxation time of a sample obtained by vulcanizing the rubber composition are measured by a solid echo method by using a pulse technique NMR apparatus at 25° C., a relaxation curve (free induction decay curve) obtained based on the unvulcanized sample is separated into two components, i.e., a component (S₀) having a short relaxation time and a component (L₀) having a long relaxation time, a relaxation curve (free induction decay curve) obtained based on the vulcanized sample is separated into two components, i.e., a component (S) having a short relaxation time and a component (L) having a long relaxation time, a weighted average value (T₀) of a relaxation time of the component (S₀) and a relaxation time of the component (L₀) and a relaxation time (Tₛ) of the component (S) satisfy Tₛ/T₀ ≥ 0.26, and a volume (Vs) of the component (S) and a volume (V_{L}) of the component (L) satisfy V_{S}/V_{L} ≥ 0.26.

The rubber composition according to the invention can further contain a sulfur-containing silane coupling agent and an alkylalkoxysilane.

A content of the silica can be 5 parts by mass to 150 parts by mass with respect to 100 parts by mass of the diene rubber, a content of the sulfur-containing silane coupling agent can be 3 mass% to 15 mass% with respect to the content of the silica, and a content of the alkylalkoxysilane can be 10 mol% to 300 mol% with respect to the sulfur-containing silane coupling agent.

The sulfur-containing silane coupling agent can have a sulfide group.

The alkylalkoxysilane can be a compound represented by a Formula (1)

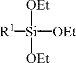

in the Formula (1), R¹ represents an alkyl group having 3 to 20 carbon atoms.

A pneumatic tire according to the invention is produced using the above rubber composition.

According to the rubber composition of the invention, conflicting performance regarding rolling resistance and wet grip performance can be improved.

### BRIEF DESCRIPTION OF THE DRAWINGS

FIG. 1 is a graph illustrating a T2 relaxation curve of a rubber in Example 1 and a result of fitting and separating the T2 relaxation curve.

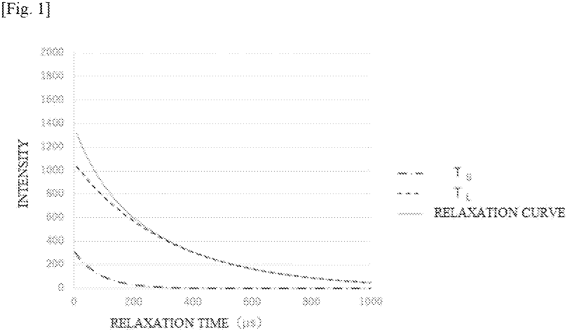

### DESCRIPTION OF EMBODIMENTS

Hereinafter, matters related to embodiments of the invention will be described in detail.

A rubber composition according to the present embodiment contains silica in a diene rubber.

The diene rubber according to the present embodiment is not particularly limited, and examples thereof include a natural rubber (NR), an isoprene rubber (1R), a butadiene rubber (BR), a styrene-butadiene rubber (SBR), a styrene-isoprene copolymer rubber, a butadiene-isoprene copolymer rubber, a styrene-isoprene-butadiene copolymer rubber, an acrylonitrile-butadiene rubber (NBR), a chloroprene rubber (CR), and a butyl rubber (HR). Those obtained by modifying a terminal or a main chain as necessary (for example, a terminal-modified SBR) or those obtained by modification to impart desired characteristics (for example, a modified NR) are also included in the concepts of the diene rubber.

In one embodiment, the diene rubber preferably contains at least one selected from the group consisting of a natural rubber, a styrene-butadiene rubber, and a butadiene rubber. The diene rubber more preferably contains a styrene-butadiene rubber. For example, the diene rubber contains, in 100 parts by mass thereof, the styrene-butadiene rubber in an amount of preferably 50 parts by mass or more, and more preferably 70 parts by mass or more, and may contain only the styrene-butadiene rubber.

The styrene-butadiene rubber may be, for example, a solution-polymerized styrene-butadiene rubber (S-SBR) or an emulsion-polymerized styrene-butadiene rubber (E-SBR). As the styrene- butadiene rubber, a modified styrene-butadiene rubber in which a terminal or a main chain is modified as necessary (for example, an amine-modified SBR or a fin-modified SBR) may be used.

The silica according to the present embodiment is not particularly limited, and wet silica such as silica made by a wet-type precipitated method or silica made by a wet-type gel-method is preferably used. A content of the silica is not particularly limited, and is preferably 5 parts by mass to 150 parts by mass, and more preferably 30 parts by mass to 100 parts by mass with respect to 100 parts by mass of the diene rubber.

The rubber composition according to the present embodiment may further contain a sulfur-containing silane coupling agent and an alkylalkoxysilane.

The sulfur-containing silane coupling agent according to the present embodiment is a silane coupling agent containing sulfur atoms in molecules, and various sulfur-containing silane coupling agents blended with the silica in the rubber composition can be used.

Specific examples of the sulfur-containing silane coupling agent include:
sulfide silanes (bissilane-based sulfide silane coupling agents) such as bis(3-triethoxysilylpropyl) tetrasulfide, bis(3-triethoxysilylpropyl) disulfide, bis(2-triethoxysilylethyl) tetrasulfide, bis(4-triethoxysilylbutyl) disulfide, bis(3-trimethoxysilylpropyl) tetrasulfide, and bis(2-trimethoxysilylethyl) disulfide;
mercaptosilanes such as 3-mercaptopropyltrimethoxysilane, 3-mercaptopropyltriethoxysilane, 3-mercaptopropylmethyldimethoxysilane, 3-mercaptopropyldimethylmethoxysilane, mercaptoethyltriethoxysilane, and “VP Si363” represented by a formula: HS—(CH₂)₃—Si(OC₂H₅)ₘ(O(C₂H₄O)ₖ—C₁₃H₂₇)ₙ and manufactured by Evonik Degussa Co., Ltd. (in the formula, m =1 in average, n = 2 in average, k = 5 in average); and
protected mercaptosilanes (that is, a silane compound having a thiol ester structure in which a mercapto group is protected by an acyl group) such as 3-octanoylthio-1-propyltriethoxysilane (formula: CH₃(CH₂)₆C(═O)S—(CH₂)₃—Si(OC₂H₅)₃) and 3-propionylthiopropyltrimethoxysilane. These sulfur-containing silane coupling agents may be used alone or in combination of two or more kinds thereof.

Among these, as the sulfur-containing silane coupling agent, a sulfide silane having a sulfide group is preferable, and one having a disulfide group is more preferable.

A content of the sulfur-containing silane coupling agent is preferably 2 mass% to 15 mass%, more preferably 2 mass% to 10 mass%, and still more preferably 2 mass% to 8 mass%, with respect to the content of the silica. That is, a total content of the sulfur-containing silane coupling agent is preferably 2 parts by mass to 15 parts by mass, more preferably 2 parts by mass to 10 parts by mass, and still more preferably 2 parts by mass to 8 parts by mass, with respect to 100 parts by mass of the silica.

The alkylalkoxysilane according to the present embodiment may be an alkyldialkoxysilane, and preferably an alkyltrialkoxysilane. The alkylalkoxysilane preferably has an alkyl group having 3 to 20 carbon atoms, and specifically, an alkyltriethoxysilane represented by the following Formula (1) is preferably used. In the Formula (1), R¹ represents an alkyl group having 3 to 20 carbon atoms, preferably an alkyl group having 6 to 20 carbon atoms, and more preferably an alkyl group having 10 to 20 carbon atoms.

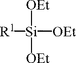

A content of the alkylalkoxysilane is preferably 10 mol% to 300 mol%, more preferably 15 mol% to 100 mol%, and still more preferably 15 mol% to 50 mol%, with respect to the content of the sulfur-containing silane coupling agent.

In addition to the above components, compounding chemicals such as a reinforcing filler, a process oil, a softener, a plasticizer, a wax, an antiaging agent, sulfur, and a vulcanization accelerator, which are generally used in the rubber industry, can be appropriately blended within a normal range in the rubber composition according to the present embodiment

As the reinforcing filler, carbon black may be blended in addition to the silica. That is, as the reinforcing filler, silica may be used alone, or carbon black and silica may be used in combination. A content of the reinforcing filler is not particularly limited, and is, for example, preferably 5 parts by mass to 150 parts by mass, more preferably 30 parts by mass to 100 parts by mass, and still more preferably 30 parts by mass to 80 parts by mass, with respect to 100 parts by mass of the diene rubber. Preferably, the reinforcing filler contains silica as a main component, and a content of carbon black is preferably 10 parts by mass or less, and more preferably 5 parts by mass or less, with respect to 100 parts by mass of the diene rubber.

The rubber composition according to the present embodiment can be produced by kneading according to a common method by using a mixer such as a Banbury mixer, a kneader, or a roll that is generally used. As a preferred embodiment, in a first mixing stage, an additive other than a alkylalkoxysilane, a vulcanization agent and a vulcanization accelerator is added to and mixed with the diene rubber at 80° C. to 120° C. for 3 to 7 minutes, and then as a second mixing stage, the alkylalkoxysilane is added to and mixed with the obtained mixture at 80° C. to 120° C. for 2 to 5 minutes, and as a final mixing stage, the vulcanization agent and the vulcanization accelerator are added to and mixed with the obtained mixture to prepare a rubber composition. When the alkylalkoxysilane is added and mixed in the second mixing stage, it is easy to improve conflicting performance regarding rolling resistance and wet grip performance.

In the rubber composition according to the present embodiment, a spin-spin relaxation time of an unvulcanized sample made of the diene rubber and a spin-spin relaxation time of a sample obtained by vulcanizing the rubber composition are measured by a solid echo method by using a pulse technique NMR apparatus at 25° C., a relaxation curve (free induction decay curve) obtained based on the unvulcanized sample is separated into two components, i.e., a component (S₀) having a short relaxation time and a component (L₀) having a long relaxation time, a relaxation curve (free induction decay curve) obtained based on the vulcanized sample is separated into two components, i.e., a component (S) having a short relaxation time and a component (L) having a long relaxation time, a weighted average value (T₀) of a relaxation time of the component (S₀) and a relaxation time of the component (L₀) and a relaxation time (Tₛ) of the component (S) satisfy T_{s/}T₀ ≥ 0.26, and a volume (Vₛ) of the component (S) and a volume (V_{L}) of the component (L) satisfy V_{S}/V_{L} ≥ 0.26,

In a short phase, a rubber component having a stronger constraint from silica has a shorter relaxation time, and a rubber component having a weaker constraint has a longer relaxation time, and molecular mobility of the rubber composition can be evaluated according to the ratio (Tₛ/T₀). That is, since the rubber composition satisfies the ratio Tₛ/T₀ ≥ 0.26 and the rubber component having a weak constraint by silica is present in a certain amount in the short phase, it is possible to sensitively absorb stress from external stimulus and it is easy to improve the conflicting performance regarding the rolling resistance and the wet grip performance.

In addition, since the rubber composition satisfies the ratio V_{S}/V_{L} ≥ 0.26 and the rubber component constrained by silica in the rubber composition is present in a certain amount, it is easy to improve the conflicting performance regarding the rolling resistance and the wet grip performance in the entire rubber composition.

Conditions for the rubber composition and measurement conditions when pulse NMR is measured, and calculation methods of a short phase fraction (Short-phase fraction) and a long phase fraction (Long-phase fraction) are described in Examples described later.

The rubber composition obtained in this manner can be applied to portions of a tire such as a tread or a sidewall of a pneumatic tire of various uses and sizes such as a tire for a passenger car or a large-sized tire for a truck or a bus. That is, the rubber composition is molded into a predetermined shape by, for example, extrusion according to a common method, and is combined with other parts to produce a green tire, and then the green tire is subjected to vulcanization molding at, for example, 140° C. to 180° C., whereby a pneumatic tire can be produced. Among these, it is particularly preferable to use the rubber composition as a blend for a tread of a tire.

### EXAMPLES

Hereinafter, Examples of the invention will be illustrated, but the invention is not limited to these Examples.

According to blending (parts by mass) shown in Tables 1 and 2, a rubber component was masticated at 100° C. for 30 seconds by using a labo mixer (300 cc) manufactured by Daihan Co., Ltd., then silica, a silane coupling agent, zinc oxide, and stearic acid were charged thereto, and the mixture was kneaded at 100° C. for 240 seconds and then discharged. Next, the discharged rubber composition and an alkylalkoxysilane were charged into the labo mixer, kneaded at 100° C. for 180 seconds, and then discharged. Further, the discharged rubber composition, sulfur, and a vulcanization accelerator were charged into the labo mixer and kneaded for 60 seconds, and discharged. The obtained unvulcanized rubber composition was subjected to sheeting by using two rolls so as to have a thickness of 2 mm, and then subjected to vulcanization pressing at 160° C. for 20 minutes to obtain a vulcanized sample.

Details of each component in Tables 1 and 2 are as follows.
S-SBR: “SL563” manufactured by JSR Corporation, terminal tin-modified
Silica: “Nipsil AQ” manufactured by Tosoh Corporation
Sulfur-containing silane coupling agent: “Si75” manufactured by EVONIK Industries
Alkylalkoxysilane 1: “propyltriethoxysilane” manufactured by Tokyo Chemical Industry Co., Ltd.
Alkylalkoxysilane 2: “hexyltriethoxysilane” manufactured by Tokyo Chemical Industry Co., Ltd.
Alkylalkoxysilane 3: “octadecyltriethoxysilane” manufactured by Tokyo Chemical Industry Co., Ltd.
Zinc oxide: “Zinc Oxide Grade 3” manufactured by Mitsui Mining & Smelting Co., Ltd.
Stearic acid: “LUNAC S-20” manufactured by Kao Corporation
Sulfur: “Powdered sulfur” manufactured by Tsurumi Chemical Industry Co., Ltd.
Vulcanization accelerator 1: “SOXINOL CZ” manufactured by Sumitomo Chemical Co., Ltd.
Vulcanization accelerator 2: “NOCCELER D” manufactured by Ouchi Shinko Chemical Industrial Co., Ltd.

The obtained vulcanized sample was subjected to a pulse NMR measurement. Specifically, JNM-MU25A manufactured by JEOL was used, and at a measurement temperature 25° C., about 1 g of the sample cut into a 1 mm square was charged into a glass tube with a diameter of 10 nun, and a T2 relaxation time was measured by a solid echo method. By approximating an obtained relaxation curve M (t) using the following equation, the relaxation time was separated into two components of a short phase (S) and a long phase (L), and a T2 relaxation time (Tₛ•T_{L}) and a component fraction (V_{S}•V_{L}) of each phase were calculated. In the following equation, calculation was made while taking a Weibull coefficient (W) as 1.

$$\begin{matrix}\text{M} \left(\text{t}\right) = {\text{MO}}_{\text{S}} ∗ \text{EXP} \left(- \left(\text{T} / {\text{T}}_{\text{S}}\right) {}_{}^{\hat{}}{\text{W}}\right) + {\text{MO}}_{\text{L}} ∗ \text{EXP} \left(- \left(\text{T} / {\text{T}}_{\text{L}}\right) {}_{}^{\hat{}}{\text{W}}\right) \\ {\text{MO = MO}}_{\text{S}} + {\text{MO}}_{\text{L}} \\ {\text{V}}_{\text{S}} = {\text{MO}}_{\text{S}} / \text{MO} \\ {\text{V}}_{\text{L}} = {\text{MO}}_{\text{L}} / \text{MO}\end{matrix}$$

In addition, a relaxation time in an unvulcanized state of a single rubber component (here, a single S-SBR) used in each rubber composition was measured. From the relaxation curve M (t) obtained in the same manner as described above, the relaxation time was separated into two components of a short phase (S₀) and a long phase (L₀), and a T2 relaxation time (T_{S}•T_{L}) and a component fraction (V_{S}•V_{L}) of each phase were calculated. A weighted average of the relaxation times of the two components was calculated using the following equation and was set to T₀. A ratio (T_{S}/T₀) of the relaxation time of the short phase of the vulcanized sample to the calculated T₀ was calculated.

$${\text{T}}_{0} = \left(\left({\text{V}}_{\text{S}} ∗ {\text{T}}_{\text{S}} + {\text{V}}_{\text{L}} ∗ {\text{T}}_{\text{L}}\right) / 100\right)$$

Regarding the obtained vulcanized samples, rolling resistance and wet grip performance were evaluated, a ratio of the wet grip performance to the rolling resistance was obtained, and results were shown in Tables 1 and 2. Measurement methods for evaluation are as follows.
Rolling resistance (RR): A loss coefficient tanδ was measured at a frequency of 10 Hz, an electrostatic strain of 10%, a dynamic strain of 1%, and a temperature of 60° C. by using a viscoelasticity tester manufactured by Ueshima Seisakusho Co., Ltd., and measured values were expressed as indexes with a value of Comparative Example 1-1 in Table 1 and a value of Comparative Example 2-1 in Table 2 which were each set as 100. The smaller the index, the better the rolling resistance.
Wet grip performance (wet): A loss coefficient tanδ was measured at a frequency of 10 Hz, an electrostatic strain of 10%, a dynamic strain of 1%, and a temperature of 0° C. by using a viscoelasticity tester manufactured by Ueshima Seisakusho Co., Ltd., and measured values were expressed as indexes with a value of Comparative Example 1-1 in Table 1 and a value of Comparative Example 2-1 in Table 2 which were each set as 100. The larger the index, the better the wet grip performance.
Ratio of wet grip performance to rolling resistance (wet/RR): A value of tanδ at 0° C., i.e., the wet grip performance, was divided by a value of tanδ at 60° C., i.e., the rolling resistance performance. The obtained values and indexes thereof are shown in Tables 1 and 2. The indexes in each table were expressed as indexes with a value of Comparative Example 1 in Table 1 and a value of Comparative Example 2-1 in Table 2 which were each set as 100. The larger the value, the better conflicting performance regarding the rolling resistance and the wet grip performance.

TABLE 1

| | Comparative Example 1-1 | Comparative Example 1-2 | Example 1-1 | Example 1-2 | Example 1-3 | Example 1-4 | Example 1-5 | Example 1-6 | Example 1-7 | Example 1-8 | Example 1–9 |
|---|---|---|---|---|---|---|---|---|---|---|---|
| S-SBR | 100 | 100 | 100 | 100 | 100 | 100 | 100 | 100 | 100 | 100 | 100 |
| Silica | 75 | 75 | 75 | 75 | 75 | 75 | 75 | 75 | 75 | 75 | 75 |
| Sulfur-containing silane coupling agent | 6.0 | - | 5.4 | 4.5 | 3 | 1.5 | 5.4 | 4.5 | 3.0 | 1.5 | 3.0 |
| Alkylalkoxysilane 1 | - | 2.6 | 0.3 | 0.7 | 1.3 | 2.0 | - | - | - | - | - |
| Alkylalkoxysilane 2 | - | - | - | - | - | - | - | - | - | - | 1.5 |
| Alkylalkoxysilane 3 | - | - | - | - | - | - | 0.5 | 1.3 | 2.6 | 3.9 | - |
| Zinc oxide | 2 | 2 | 2 | 2 | 2 | 2 | 2 | 2 | 2 | 2 | 2 |
| Stearic acid | 2 | 2 | 2 | 2 | 2 | 2 | 2 | 2 | 2 | 2 | 2 |
| Sulfur | 1.8 | 1.8 | 1.8 | 1.8 | 1.8 | 1.8 | 1.8 | 1.8 | 1.8 | 1.8 | 1.8 |
| Vulcanization accelerator 1 | 1.3 | 1.3 | 1.3 | 1.3 | 1.3 | 1.3 | 1.3 | 1.3 | 1.3 | 1.3 | 1.3 |
| Vulcanization accelerator 2 | 1.8 | 1.8 | 1.8 | 1.8 | 1.8 | 1.8 | 1.8 | 1.8 | 1.8 | 1.8 | 1.8 |
| Ratio (molar ratio (%)) of alkylalkoxysilane to sulfur-containing silane coupling agent | 0 | - | 11 | 33 | 100 | 300 | 11 | 33 | 100 | 300 | 100 |
| V_{g}/Vₜ | 0.28 | 0.25 | 0.29 | 0.26 | 0.26 | 0.27 | 0.28 | 0.28 | 0.28 | 0.30 | 0.30 |
| T_{g}/T₀ | 0.25 | 0.27 | 0.26 | 0.26 | 0.26 | 0.26 | 0.28 | 0.26 | 0.29 | 0.31 | 0.27 |
| Tanδ 0° C. wet (index) | 100 | 95 | 108 | 98 | 97 | 93 | 103 | 116 | 122 | 135 | 111 |
| Tanδ 60° C. RR (index) | 100 | 109 | 84 | 93 | 96 | 92 | 93 | 76 | 70 | 68 | 89 |
| wet/RR | 3.0 | 2.7 | 3.9 | 3.2 | 3.1 | 3.1 | 3.4 | 4.6 | 5.3 | 6.0 | 3.8 |
| wet/RR (index) | 100 | 87 | 129 | 106 | 102 | 101 | 110 | 153 | 173 | 197 | 124 |

TABLE 2

| | Comparative Example 2-1 | Comparative Example 2-2 | Example 2-1 | Example 2-2 | Example 2-3 | Example 2-4 | Example 2-5 | Example 2-6 | Example 2-7 | Example 2-8 |
|---|---|---|---|---|---|---|---|---|---|---|
| S-SBR | 100 | 100 | 100 | 100 | 100 | 100 | 100 | 100 | 100 | 100 |
| Silica | 50 | 50 | 50 | 50 | 50 | 50 | 50 | 50 | 50 | 50 |
| Sulfur-containing silane coupling agent | 4.0 | - | 3.6 | 3.0 | 2.0 | 1.0 | 3.6 | 3.0 | 2.0 | 1.0 |
| Alkylalkoxysilane 1 | - | 1.7 | 0.2 | 0.4 | 0.9 | 1.3 | - | - | - | - |
| Alkylalkoxysilane 3 | - | - | - | - | - | - | 0.3 | 0.9 | 1.7 | 2.7 |
| Zinc oxide | 2 | 2 | 2 | 2 | 2 | 2 | 2 | 2 | 2 | 2 |
| Stearic acid | 2 | 2 | 2 | 2 | 2 | 2 | 2 | 2 | 2 | 2 |
| Sulfur | 1.8 | 1.8 | 1.8 | 1.8 | 1.8 | 1.8 | 1.8 | 1.8 | 1.8 | 1.8 |
| Vulcanization accelerator 1 | 1.3 | 1.3 | 1.3 | 1.3 | 1.3 | 1.3 | 1.3 | 1.3 | 1.3 | 1.3 |
| Vulcanization accelerator 2 | 1.8 | 1.8 | 1.8 | 1.8 | 1.8 | 1.8 | 1.8 | 1.8 | 1.8 | 1.8 |
| Ratio (molar ratio (%)) of alkylalkoxysilane to sulfur-containing silane coupling agent | 0 | | 11 | 33 | 100 | 300 | 11 | 33 | 100 | 300 |
| V_{g}/Vₜ | 0.25 | 0.25 | 0.28 | 0.26 | 0.26 | 0.26 | 0.27 | 0.27 | 0.28 | 0.30 |
| T_{g}/T₀ | 0.28 | 0.31 | 0.3 | 0.29 | 0.29 | 0.3 | 0.32 | 0.30 | 0.33 | 0.36 |
| Tanδ 0° C. wet (index) | 100 | 95 | 108 | 98 | 98 | 93 | 103 | 116 | 122 | 135 |
| Tanδ 60° C. RR (index) | 100 | 109 | 84 | 93 | 96 | 92 | 93 | 76 | 70 | 68 |
| wet/RR | 6.5 | 5.6 | 83 | 6.8 | 6.6 | 6.5 | 7.1 | 9.9 | 11.2 | 12.8 |
| wet/RR (index) | 100 | 87 | 129 | 106 | 102 | 101 | 110 | 153 | 173 | 197 |

The results are shown in Tables 1 and 2, and Comparative Example 1-1 is an example in which a sulfur-containing silane coupling agent is blended without blending the alkylalkoxysilane, and a value of T_{S}/T₀ measured by pulse NMR is out of a predetermined range. Comparative Example 1-2 is an example in which the alkylalkoxysilane is blended without blending the sulfur-containing silane coupling agent, and a value of V_{S}/V_{L} is out of a predetermined range. In Comparative Example 1-2, the conflicting performance regarding the rolling resistance and the wet grip performance deteriorates as compared with Comparative Example 1-1.

On the other hand, Examples 1-1 to 1-9 are examples in which the sulfur-containing silane coupling agent and the alkyl alkoxysilane are used in combination, and the value of T_{S}/T₀ and the value of V_{S}/V_{L} measured by the pulse NMR are within a predetermined range. In these Examples, the conflicting performance regarding the rolling resistance and the wet grip performance is improved compared to Comparative Examples 1-1 and 1-2.

Comparative Example 2-1 is an example in which the sulfur-containing silane coupling agent is blended without blending the alkylalkoxysilane, and the value of V_{S}/V_{L} measured by the pulse NMR is out of a predetermined range. Comparative Example 2-2 is an example in which the alkylalkoxysilane is blended without blending the sulfur-containing silane coupling agent, and the value of Vₛ/V_{L}, is out of a predetermined range. In Comparative Example 2-2, the conflicting performance regarding the rolling resistance and the wet grip performance deteriorates as compared with Comparative Example 2-1.

On the other hand, Examples 2-1 to 2-8 are examples in which the sulfur-containing silane coupling agent and the alkyl alkoxysilane are used in combination, and the value of T_{S}/T₀ and the value of V_{S}/V_{L} measured by the pulse NMR are within a predetermined range. In these Examples, the conflicting performance regarding the rolling resistance and the wet grip performance is improved compared to Comparative Examples 2-1 and 2-2.

### Industrial Applicability

The rubber composition according to the invention can be used for a tread, a sidewall, a belt, a carcass, or the like of a tire for a passenger car or a large-sized tire for a truck or a bus.

What is claimed is:

1. A rubber composition comprising:
silica in a diene rubber, wherein
a spin-spin relaxation time of an unvulcanized sample made of the diene rubber and a spin-spin relaxation time of a sample obtained by vulcanizing the rubber composition are measured by a solid echo method by using a pulse technique NMR apparatus at 25℃,
a relaxation curve (free induction decay curve) obtained based on the unvulcanized sample is separated into two components, i.e., a component (S₀) having a short relaxation time and a component (L₀) having a long relaxation time,
a relaxation curve (free induction decay curve) obtained based on the vulcanized sample is separated into two components, i.e., a component (S) having a short relaxation time and a component (L) having a long relaxation time,
a weighted average value (T₀) of a relaxation time of the component (S₀) and a relaxation time of the component (L₀) and a relaxation time (Ts) of the component (S) satisfy Tₛ/T₀ ≥ 0.26, and
a volume (Vₛ) of the component (S) and a volume (V_{L},) of the component (L) satisfy V_{S/}V_{L} ≥ 0.26.

2. The rubber composition according to claim 1, further comprising:
a sulfur-containing silane coupling agent; and
an alkylalkoxysilane.

3. The rubber composition according to claim 2, wherein
a content of the silica is 5 parts by mass to 150 parts by mass with respect to 100 parts by mass of the diene rubber,
a content of the sulfur-containing silane coupling agent is 3 mass% to 15 mass% with respect to the content of the silica, and
a content of the alkylalkoxysilane is 10 mol% to 300 mol% with respect to the sulfur-containing silane coupling agent.

4. The rubber composition according to claim 2, wherein
the sulfur-containing silane coupling agent has a sulfide group.

5. The rubber composition according to claim 3, wherein
the sulfur-containing silane coupling agent has a sulfide group.

6. The rubber composition according to claim 2, wherein
the alkylalkoxysilane is a compound represented by a Formula (1) 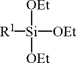
in the Formula (1), R¹ represents an alkyl group having 3 to 20 carbon atoms.

7. The rubber composition according to claim 3, wherein
the alkylalkoxysilane is a compound represented by a Formula (1) 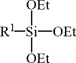
in the Formula (1), R¹ represents an alkyl group having 3 to 20 carbon atoms.

8. The rubber composition according to claim 4, wherein
the alkylalkoxysilane is a compound represented by a Formula (1) 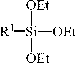
in the Formula (1), R¹ represents an alkyl group having 3 to 20 carbon atoms.

9. The rubber composition according to claim 5, wherein
the alkylalkoxysilane is a compound represented by a Formula (1) 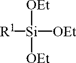
in the Formula (1), R¹ represents an alkyl group having 3 to 20 carbon atoms.

10. A pneumatic tire, which is produced using the rubber composition according to claim 1.

11. A pneumatic tire, which is produced using the rubber composition according to claim 2.

12. A pneumatic tire, which is produced using the rubber composition according to claim 3.

13. A pneumatic tire, which is produced using the rubber composition according to claim 4.

14. A pneumatic tire, which is produced using the rubber composition according to claim 5.

15. A pneumatic tire, which is produced using the rubber composition according to claim 6.

16. A pneumatic tire, which is produced using the rubber composition according to claim 7.

17. A pneumatic tire, which is produced using the rubber composition according to claim 8.

18. A pneumatic tire, which is produced using the rubber composition according to claim 9.
